(19) United States
(12) Patent Application Publication
(10) Pub. No.: US 2008/0288298 A1
(43) Pub. Date: Nov. 20, 2008

(54) Method and system for providing low-cost life insurance

(76) Inventors: Eswarahalli S. Dattatreya, Summit, NJ (US); Eshwarahalli S. Pundarika, Summit, NJ (US)

Correspondence Address: GOODWIN PROCTER LLP, 901 NEW YORK AVENUE, N.W., WASHINGTON, DC, 20001, US

(21) Appl. No.: 12/102,522

(22) Filed: Apr. 14, 2008

Related U.S. Application Data
(60) Provisional application No. 60/911,428, filed on Apr. 12, 2007.

(51) Int. Cl. G06Q 40/00

(52) U.S. Cl. 705/4

(57) ABSTRACT

The invention generally concerns systems and methods for providing low-cost insurance to a group of individuals seeking insurance. The system and method may determine a group of individuals to be insured. The individuals may be pooled into a collective entity. The entity may be provided with one or more financing instruments. The financing instruments may be used to purchase insurance policies for the individuals in the pool. In some cases the pool may hold the policies as a custodian, paying maintenance fees on the policies and distributing cash flows from the maturity of the policies.

### RELATED APPLICATIONS

This application asserts priority under 35 U.S.C. § 119(e) to U.S. Provisional Patent Application No. 60/911,428 under docket number 99999.000311, entitled “Method and System for Providing Low-Cost Life Insurance,” filed Apr. 12, 2007, which is hereby incorporated by reference in its entirety.

### FIELD OF THE INVENTION

The present invention relates generally to insurance, and more specifically to a method and system for providing low-cost life insurance.

### BACKGROUND OF THE INVENTION

In recent years, a market has developed in which lenders are willing to fund the purchase of life insurance policies by seniors. If the lending is non-recourse, the lender essentially requires economic ownership of a substantial portion of the financed policy in order to recoup the time-valued cost of the lender's financial outlay. For example, an insured party may obtain a non-recourse loan from a bank-lender to pay premiums on his or her life insurance policy. Interest will accrue on the loan until the policy matures, when the total loan amount (including the accrued interest) is paid back to the bank-lender with the policy payout. In effect, the non-recourse loan is secured by the potential payout from the life insurance policy.

This type of financing for life insurance called “non-recourse premium financing”, is typically only offered to wealthy seniors because of the larger-valued policies available to them. The loan usually lasts for a minimum of two years. If the senior dies during the first two years of the loan, the estate or family trust will have to pay back the loan, along with accrued interest and maintenance fees, from the death benefit from the life insurance policy. The remaining benefit will belong to the estate. If, on the other hand, the insured survives through the two-year mark, he will be provided with the option to pay off the loan and keep the policy, or transfer the policy to the lender and walk away.

While a policy financed via a non-recourse loan will eventually mature, the policy-holder may enjoy a longer-than-average life, during which time the loan balance continues to grow. The larger the total loan amount and/or the longer the time to repayment, the less likely the loan will be fully repaid. In other words, on any single policy, the bank-lender is exposed to mortality risk. This risk exposure may cause a bank-lender to be reluctant to lend money for the purchase of life insurance policies at attractive interest rates.

It should be readily apparent to those skilled in the art that the above situations and others of their kind do not satisfactorily address the needs and desires of consumers of insurance, providers of insurance, and the financiers of insurance in a fair and equitable fashion. Further, these situations of financed insurance leave doubt in the minds of the insured as to whether another stakeholder may “assist” in the maturity of the insured's policy. Further, these methods do little to curb the threat of mortality and longevity risks present to both insurers and financiers.

More broadly, no system currently exists in which a consumer can effectively gain low-cost insurance financed by a lender and provided by an insurance carrier in a manner that benefits all parties involved.

Other problems and drawbacks also exist.

### SUMMARY OF THE INVENTION

Accordingly, one aspect of the invention is to address one or more of the drawbacks set forth above.

According to embodiments of the present invention, a method and system for providing low-cost life insurance may enable a group of seniors to obtain life insurance policies through a pooling entity. The pooling entity may pool individual life insurance policies into a portfolio and use the entire portfolio as collateral and a repayment source for the monies borrowed to purchase the policies. This arrangement benefits both the insured and the bank-lender as the above-described mortality risk is spread across multiple policyholders. Note that the invention is not limited to use by seniors, as that term is ordinarily understood.

According to one embodiment of the present invention, a group of persons interested in purchasing low cost policies may set up and/or become members of a pooling entity in the form of a trust, limited liability company (LLC), limited liability partnership (LLP), S-corporation, C-corporation, cooperative, or any other legal form as appropriate under the relevant state or federal law. The pooling entity may be set up so that it has insurable interest in the members so that it may purchase and hold life insurance policies on the lives of the individual members. The policy premiums may be financed with debt (e.g., a credit line or a loan facility). Cash inflows from maturing policies may be used to pay down the debt first, with the remainder divided among the members according to a predetermined formula. Since early-maturing policies will offset the impact of those policies that mature later, the bank-lender will be exposed to a lower aggregate mortality risk with the portfolio of policies than with a single policy.

The present invention, which in some instances may be referred to as the “Group Life Organization,” or “GLO” product, has numerous benefits and advantages. For example, the pooling of various individuals into a collective borrowing entity allows for a lender to dramatically mitigate the mortality risk normally present in the financing of insurance policies (and other mortality-based products such as annuities.)

The ability for an insurance carrier to spread the risk of early maturity of policies over a large pool of individuals is advantageous as it greatly reduces the risk normally present when providing insurance to elderly and other at-risk individuals.

Further, the ability to mitigate the risks of both lenders and carriers is advantageous as it allows individuals seeking insurance to receive insurance at lower interest rates and with lower premiums. Some individuals will even be able to receive insurance through an insurance pool where they would not be able to do so individually.

Because the invention allows all parties to a financed insurance arrangement to benefit from the provision, maintenance, and maturity of insurance policies, all parties will be enriched in the form of greater cash flow, easier maintenance of the insurance arrangement, and reduced stress from the start to finish of the life of the policies involved.

Other embodiments, uses and advantages of the present invention will be apparent to those skilled in the art from consideration of the specification and practice of the invention disclosed herein. The specification and examples should be considered exemplary only.

Accordingly, it is one object of the present invention to overcome one or more of the aforementioned and other limitations of existing systems and methods for financed insurance inherent in the financing of individual insurance policies.

It is another object of the invention to provide a system and method for providing low-cost life insurance to individuals seeking insurance.

It is another object of the invention to provide a system and method that reduces the mortality risk inherent in the financing of insurance policies.

It is another object of the invention to provide a system and method that allows for the pooling of individuals for the purpose of leveraging group buying power when purchasing insurance.

It is another object of the invention to provide a system and method that allows for the pooling of individuals for the purpose of leveraging group buying power when seeking financing.

It is another object of the invention to provide a system and method that provides anonymity amongst pool participants to prevent the threat of assisted maturity of insurance policies.

Other embodiments of the invention include pooling of other mortality-based products such as annuities instead of or in addition to pooling of life insurance policies

The accompanying drawings are included to provide a further understanding of the invention and are incorporated in and constitute part of this specification, illustrate several embodiments of the invention and, together with the description, serve to explain the principles of the invention. It will become apparent from the drawings and detailed description that other objects, advantages and benefits of the invention also exist.

Additional features and advantages of the invention will be set forth in the description that follows, including the figures, and in part will be apparent from the description, or may be learned by practice of the invention. The objectives and other advantages of the invention will be realized and attained by the system and methods, particularly pointed out in the written description and claims hereof as well as the appended drawings.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 illustrates a GLO System in accordance with an embodiment of the invention.

FIG. 2 illustrates a system for providing insurance to insurance seekers according to an embodiment of the invention.

FIG. 3 illustrates the various channels for acquiring individuals interested in low-cost insurance that are contemplated by some of the various embodiments and aspects of the invention.

FIG. 4 illustrates a method for selecting members for inclusion in a pooled insurance entity according to one of the embodiments of the invention.

FIG. 5 illustrates a method for selecting carriers for insuring members of a pooled insurance entity according to one of the embodiments of the invention.

FIG. 6 illustrates a method for selecting optimal lenders for financing pooled insurance policies according to one of the embodiments of the invention.

FIG. 7 illustrates methods of updating individuals and entities on the various insurance pools in operation or offered by a service provider according to various embodiments of the invention.

FIG. 8 illustrates methods of maintaining or improving the operation of an insurance pool according to various embodiments of the present invention.

FIG. 9(a) illustrates the distribution of cash flow generated from the maturity of a policy in an insurance pool according to various embodiments of the invention.

FIG. 9(b) illustrates the prioritized distribution of cash flow generated from the maturity of a final policy in an insurance pool according to various embodiments of the invention.

FIG. 10 illustrates various social networking-related applications available to members of an insurance pool according to various embodiments and aspects of the invention.

FIG. 11 illustrates various applications of a longevity index created by the operation of an insurance pool according to various embodiments and aspects of the invention.

### DETAILED DESCRIPTION OF THE INVENTION

Embodiments of the present invention are directed to an insurance providing system and method that allows for insurance to be available to individuals and other entities as a lower cost than traditionally available.

The GLO System

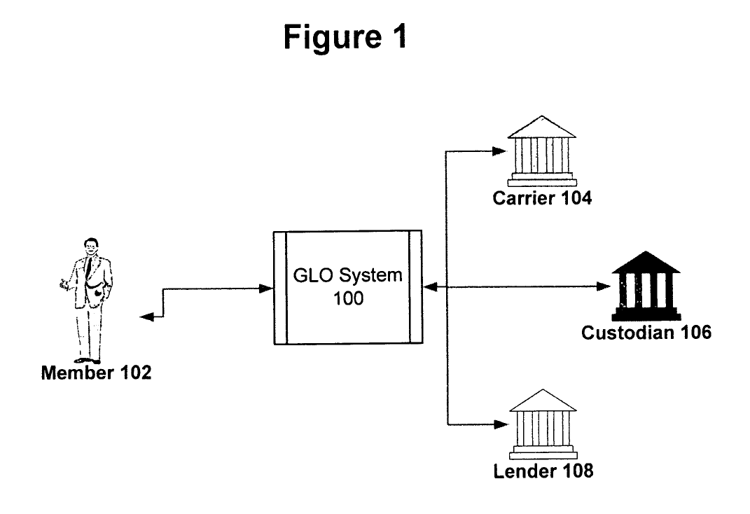

FIG. 1 illustrates a GLO System 100 in accordance with an embodiment of the invention. In some aspects of the invention, a GLO System 100 may interface with at least one member 102, at least one carrier 104, at least one custodian 106, and at least one lender 108. The GLO System 100 may control or influence the interactions between the various entities (102-108) involved in the provision of low-cost insurance. According to various embodiments of the invention, a member 102 may desire to obtain an insurance product. The member 102 may apply for insurance using the GLO System 100. The member may be an individual or another type of entity which can be provided insurance, such as a business or a household or association or other group.

In one embodiment of the invention, the insurance may be a life insurance policy. In some embodiments, the GLO System may take the member's application and arrange for the issuance of an insurance policy from carrier 104. According to an embodiment of the invention, the GLO System 100 may combine the application of member 102 with other applications for insurance from other individuals. Embodiments of the invention contemplate the GLO System 100 arranging for a lender 108 to provide financing products for the insurance policy(ies). According to some aspects of the invention, a custodian 106 may be provided by the GLO System 100 in order to hold the insurance policy and financing products for the member. The custodian 106, along with the GLO System 100, may then administer or maintain the insurance policy(ies) and financial products throughout the life of the policy and products on behalf of the member. Multiple member policies and financing products may be maintained by custodian 106. Various embodiments, described in more detail herein, consider multiple custodians, lenders, carriers, and members accessing or using the GLO System 100.

The GLO System 100 may include instructions executed on a computer. The GLO System 100 as shown in FIG. 1 may be or include a computer system or multiple computer systems. The GLO System 100 may be described in the general context of computer-executable instructions, such as program modules, being executed by a computer. Generally, program modules include routines, programs, objects, components, data structures, etc. that perform particular tasks.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network (e.g., Internet, intranet, LAN, PAN, etc.). In a distributed computing environment, program modules may be located in both local and remote computer storage media including memory storage devices.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BCOS™ operating system, the Macintosh™® operating system, the Apache™ operating system, an OpenStep™ operating system or another operating system or platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The GLO System 100 may include a plurality of software processing modules stored in a memory as described above and executed on a processor in the manner described herein. The program modules may be in the form of any suitable programming language, which may be converted to machine language or object code to allow the processor or processors to read the instructions. That is, written lines of programming code or source code. in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (IAN), the Internet, intranets, and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include ICP/IP, UDP, or OSI for example. For wireless communications, communications protocols may include Bluetooth, Zigbee, IrDa or other suitable protocol. Furthermore, components of the system may communicate through a combination of wired or wireless paths. For some aspects of the invention, such as for the transfer of payments, the communications infrastructure may include networked systems such as the Electronic Funds Transfer (EFT) network, trade exchanges, and other communication channels known in the industry for implementing trading transactions (which may include settlement operations) such that those described herein.

Although many other internal components of the computer arc not shown, those of ordinary skill in the art will appreciate that such components and the interconnections are well known. Accordingly, additional details concerning the internal construction of the computer need not be disclosed in connection with the present invention.

Formation

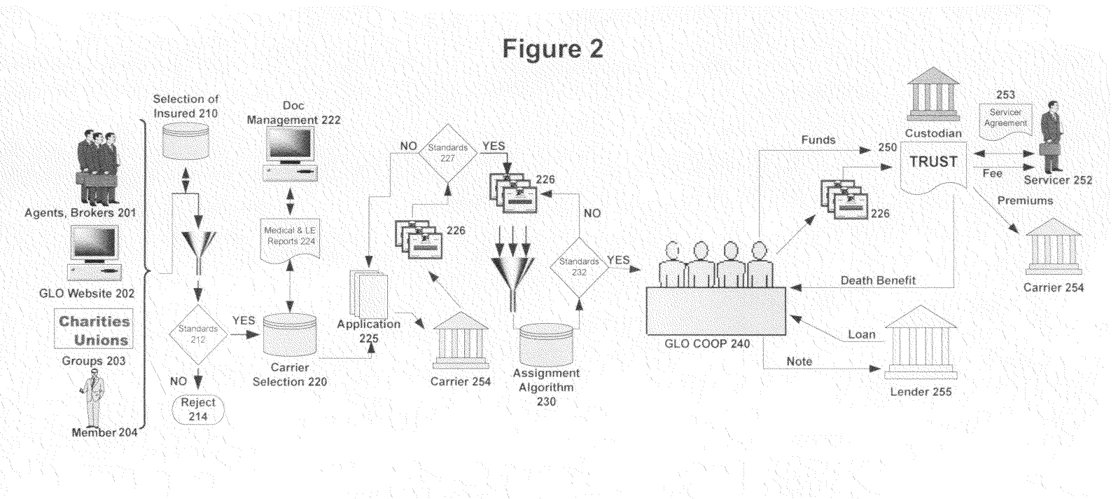

FIG. 2 illustrates a system for providing insurance to insurance seekers according to an embodiment of the invention. This method may be practiced by a service provider, such as a GLO service provider. In various aspects of the invention, an individual seeks insurance. Various embodiments contemplate other entities also seeking insurance. Yet other embodiments or aspects of the invention contemplate multiple individuals seeking insurance. In the description below, a reference to an individual is intended to also contemplate the application of the system to multiple individuals (or to groups or other entities that can acquire life insurance). The individual or individuals seeking insurance may enter the method of FIG. 2 through an agent or broker of insurance 201. These agents or brokers may have a preexisting relationship with the individuals or with a service provider. Aspects of the invention may see individuals reaching a service provider via a website 202 operated by or on behalf of a service provider. In those aspects, an individual or multiple individuals may initiate interactions with a service provider through forms, links, or other website techniques well-known to those of skill in the art. Still other individuals may reach the GLO service provider through membership in a group or organization 203. Some of the groups or organizations in accordance with various aspects of the invention may include charities, unions, website memberships, gym membership, retirement community membership, the AARP™, a professional association, a workplace, or any other organization, group, or association. Still other aspects of the invention contemplate individuals 204 reaching a service provider through various other methods. In some instances, an individual may walk into the GLO service provider's offices, call a service provider, visit a service provider kiosk, be directed to a service provider from affiliate or feeder entities such as websites, advertisers, a commissioned sales force, or other methods appreciated by those in the art. Other group and individual acquisition methods and channels are also available.

Once an individual has contacted a service provider (or vice versa), the individual may be screened by the service provider in a selection segment. In some aspects, the individual will complete an initial questionnaire or application for insurance. This initial questionnaire or application may be submitted to a service provider in order for a service provider to complete the selection segment. In some embodiments, the selection segment may screen or review one or multiple individuals according to predetermined or variable criteria or a set of standards 212. In aspects where a questionnaire or application is submitted, these criteria may appear on the questionnaire. According to some aspects of the invention, criteria may include age, residence (state, county or zip-code or other geographic or political sub-division, etc), a longevity estimate, net worth, retirement income, other insurance holdings, or any other aspects of the individual relating to their identity, credit, or other factors such as life-style and behavioral practices (e.g., does the individual exercise regularly? does the individual consume alcohol? Does the individual smoke? etc.). In some embodiments, the questionnaire or application may also contain information that may be required later in the provision of insurance to the individual. The data acquired by the selection process may be input into a database or other storage medium 210. According to some embodiments of the invention, the selection process then gathers information from the database 210 and evaluates the individual's questionnaire or application based on a set of standards 212. In some aspects, these standards may be adjusted based upon requirements of lenders 255 and insurance carriers 254. Standards may also fluctuate depending upon the residence of the individual (state, county or zip-code or other geographic or political sub-division, etc), the age of the individual, any of the other criteria mentioned above, and any other criteria typically considered in issuing life insurance policies. In one aspect, regulations or laws governing the provision of insurance may affect these standards.

If an individual, or the individual through his application or questionnaire, meets the applicable standards, he may move to the carrier selection segment of the system. According to some aspects of the invention, if an individual does not meet the requirements or standards of the selection segment, the individual is rejected by the service provider. Other aspects or embodiments contemplate an individual being allowed to reapply with the service provider. In some aspects, the subsequent application may be at a later time period, when the individual has different responses to the application or questionnaire, or when the requirements or standards of a service provider, carrier, or lender change. In some embodiments of the invention, the individual may be notified by a service provider when the individual is eligible to reapply. In other embodiments, the individual may be told, along with the rejection, what circumstances must change for the individual to reapply. The individual may also be told the specific reasons for rejection.

In accordance with some embodiments of the invention, a carrier selection segment 220 may follow the selection segment. Other embodiments may contemplate a predetermined carrier, such that the carrier selection segment is not present. In various aspects of the embodiments containing a carrier selection segment, the individual or individuals that have met the standards of the preceding segment may be evaluated with respect to various insurance carriers. As different insurance carriers may have different requirements, specialties, strengths, weaknesses, and other characteristics, various aspects of the invention may contemplate that one carrier may be better suited for one individual, while another carrier may be better suited to service another individual. In order to select the optimal carrier for an individual, medical reports or longevity estimate reports 224 may be gathered from one or many document management sources 222. In some aspects of the invention, the medical reports may come from a medical history file provided by the individual or the individual's physician. Other methods of gathering medical records are contemplated by various aspects and embodiments of the invention, as will be appreciated by those of skill in the art. In some aspects of the invention, longevity estimates may be gathered by the carrier selection segment. These longevity estimates may be calculated internally or received from an external source. Internal estimates may, according to some embodiments of the invention, be based upon doctors' opinions, medical records, actuarial experience and data, census data, general population trends, and information or data relating to similarly situated individuals. Some external sources may be third party consultants such as actuarial organizations. Some aspects contemplate the use of both internally and externally generated longevity estimates.

Once reports and estimates are gathered by the carrier selection segment, an analysis of an “optimal” or best-suited (hereinafter, optimal) carrier may be conducted. In some aspects of the invention, the carrier selection segment may evaluate each of the available carriers based on the gathered report and estimate information. In some embodiments, simulations may be run by the carrier selection segment to determine the optimal carrier. In other embodiments, the carrier selection segment may separately apply to each of the available carriers and determine the best or optimal offer provided by carriers. Other aspects and embodiments contemplate other methods of analyzing or evaluating the optimal carrier selection according to methods appreciated by those in the art, including, for example, diversification of credit risk from the point of view of the lender.

According to various embodiments of the invention, an application for an insurance policy 225 may be created and/or submitted by a service provider on behalf of the individual. In various aspects of the invention, the application may be completed using any questionnaire or application data, any medical or longevity expectancy data, or any other information available to the service provider. In other aspects of the invention, the individual may complete additional questionnaires in order for the service provider to complete the application. In other aspects, the individual may complete the application for insurance and provide the completed application to the service provider or to the carrier directly. Still other aspects and embodiments consider a combination of these methods of completing the application for insurance. Information to be contained on the application for insurance may include information relating to the health of the individual, the financial status of the individual, the desired insurance level or value desired by the individual, information identifying the service provider, other insurance policy parameters, or any other information mentioned herein, such as the identity of the beneficiaries of the policy.

According to various embodiments of the invention, a completed application may then be submitted to the selected carrier 254. The carrier may then process the application and produce one or multiple insurance policies 226 to offer to the individual. In various aspects of the invention, the policy or policies may be provided directly to the service provider, which may be given authority to act on behalf of the individual. In other aspects, the policies may be provided to the individual, and the individual may forward the policies to the service provider. Still other aspects contemplate circumstances where the policy or policies may be forwarded to both the service provider and the individual.

Upon receipt of the policy or policies 226, the service provider may evaluate the policy or policies according to a set of policy standards 227. According to some embodiments of the invention, these policy standards may include requirements of the service provider, of the lender 255 (if a lender has already been identified), of the individual, of a regulation or law, or of any other source appreciated by those of skill in the art. These standards may include a policy value or threshold, a periodic premium value or threshold, maturity provisions, any beneficiary restrictions (such as those preventing a cooperative, trust, or other entity from being a beneficiary, in whole or in part), any ownership restrictions (such as those preventing a cooperative, trust, or other entity holding the policy as collateral), or any other standard. According to some of the various embodiments of the invention, if the policy or policies do not meet the policy standards, a new application 225 may be prepared. In some of these embodiments, the new application may be directed to the same or to a different carrier. If directed to the same carrier, the new application may be changed in one or more aspects such that a different and acceptable policy may be offered by the carrier. If directed to a different carrier, aspects of the invention may contemplate the new application being identical or similar in content to the prior application. In these aspects, differences may be caused by differences in the format of an application to another carrier, or differences in the content required by another carrier. Still other aspects of the invention may contemplate differences in substance between the new application to a new carrier and the prior filed application to the prior carrier being due to the service provider's knowledge of policies provided by the new carrier. As an illustrative example, one carrier may provide better rates for higher-valued policies than another carrier, which may specialize in low-valued policies. In this example, if the first carrier generated an unacceptable policy or policies, the new application may be adjusted so that the requested policy value is reduced slightly in order to get the second carrier to offer more optimal policies. In other aspects of the invention, if a policy is offered from a carrier that meets the policy standards, the policy may then be passed on to assignment segment 230. If more than one offered policy meets the policy standards, the optimal policy may be determined and elected to progress to assignment segment 230. In other aspects of the invention, all acceptable policy offers may progress to assignment segment 230.

According to some aspects and embodiments of the invention, there may be multiple entities or “pools” 240 in which an individual may be placed. These pools, also known as “coops,” may allow an individual to leverage efficiencies of size when applying for financing from a lender 255 or when applying for insurance from a carrier 254, as mentioned above. In aspects where a purpose of the pool is to secure better insurance policies from carriers, the process of pooling may occur prior to the application for insurance. According to various embodiments of the invention, a purpose of the pool may be to secure financing for the insurance policies of the membership of the pool. In some aspects, the pool may finance the purchase and maintenance of the policies under a line of credit provided by a lender(s). In other aspects, other financial products may be utilized by the pool in order to finance the purchase and maintenance of policies. Some of these financial products may be a secured loan, an unsecured loan, a factoring agreement, or any other form of financial product appreciated by those of skill in the art. In some embodiments, the pool may take custodial ownership of the policies of the pool membership. In various aspects of the invention, custodial ownership may include, beyond the provision of financing for the policies of the pool, the repayment of financing, payment of maintenance fees associated with the pool and the policies, and the payment of value or benefits to the membership.

In some of the various embodiments, an individual with an acceptable policy or policies may then be assigned membership in a pool. That pool may maintain custodial ownership of the policies of its members, including the individual's policy or policies. A membership assignment segment 230 may conduct this assignment. Assignments into one of a set of pools may be made based on various standards or attributes 232 of the individual, such as age, longevity estimate, policy size, policy premium, residence (state, county or zip-code or other geographic or political sub-division, etc), any factors previously considered or of record, or any other factors appreciated by those of skill in the art. Assignments may also be made based on a goal of diversifying the various standards or attributes within each of the individual pools. If an acceptable or optimal pool is found for the individual, the individual may be placed in the optimal or acceptable pool.

Some aspects of the invention contemplate an individual being given a choice of acceptable pools. In those aspects, the choice of the individual may decide the pool in which he will be a member. If an acceptable pool is not found for the individual, the individual may be vetted through the membership assignment segment again at a later time. In some embodiments, the individual may find an acceptable pool upon a subsequent placement in the membership assignment segment because of changed circumstances, additional individuals involved in the pool, or additional pools available. Other embodiments may consider creating a new pool for an individual if no acceptable pool is available. Still other embodiments may create new pools for an individual even if an acceptable pool is available in order to better diversify the memberships of the available pools or to create availability for future or subsequent individuals. According to other aspects of the invention, if only one pool exists, the individual may be automatically placed in that pool, may be evaluated based on standards as mentioned above, or may be placed in a newly formed pool.

A pool may benefit the lender, in that it may reduce the lender's mortality risk, which in turn reduces the risk of nonpayment due to the mortality risk, ordinarily associated with financed insurance. As an illustrative example, positive cash flows from any early-maturing policies will be able to offset negative cash flows from late-maturing policies. In effect, the larger the pool, the more a lender's mortality risk should be mitigated. This arrangement may then allow a lender to more accurately project expected cash flows from the portfolio of insurance policies to be financed.

Aspects of the invention contemplate another effect upon the lender caused by the pooling of policies. In this aspect, if the an interest rate on the financing product is low, the portfolio's ability to mitigate mortality risk and improve the chances of full repayment may justify offering the low interest rate to the lender. In some aspects, these properties of the portfolio may justify offering an even lower interest rate on the financing product. According to some embodiments of the invention, the portfolio of insurance policies to be financed from the lender may also be used as collateral in the overall financial transaction. In some of the various embodiments of the invention, a lender may provide one financing product to cover the entire pool, a financing product for each member of the pool, a financing product for each of the policies in the pool, or some amount of financing products that is less than either the number of members or policies in the pool. In aspects where multiple financing products are issued to a single pool, those financing products may be heterogeneous or homogeneous products.

According to some of the various embodiments of the invention, a pool may be organized in any of a plurality of fashions. A pool may be any legal entity such as a cooperative, a trust 250, a statutory trust, a common law trust, a charitable trust, an LLC, an LLP, an S-corporation, a corporation, an association, a partnership, a limited partnership, a general partnership, or any other appropriate entity appreciated by those of skill in the art. In some aspects of the invention, pools may consist of nested entities such that a parent-subsidiary relationship exists between the entities. As an illustrative example, government regulations may require that any entity holding insurance in a custodial manner must be located in the jurisdiction in which the insured individual resides. In that example, a pool may consist of a holding entity, such as an LLC or a trust, that is the parent of multiple trusts located in each of the jurisdictions in which members of the pool reside.

It is possible that members of an insurance pool may not want other members of the pool to know their identity. In addition to the usual privacy issuer, one possible concern, remote though it maybe, is that, when dealing with a life insurance pool, members have an interest in the early maturity of other member policies in the pool. In this illustrative example, members may fear the assisted early maturity of their policies by other members if identities of all members are shared amongst the pool. Accordingly, embodiments of the invention may provide for anonymity amongst the membership of a pool. These embodiments may provide the pools in such a structure where a trustee is able to manage the pool to maturity, including any payments to the membership (upon maturity of policies and the trust itself), without disclosing the identity of any individual member to any other members.

According to various aspects of the invention, pools may be operated by a trustee. In some of these aspects, the trustee may hire a servicer 252 to maintain the insurance policies of the membership. In some aspects, the servicer may be responsible for communicating with the lender or the carrier, or the membership. The servicer may also be responsible for the payment of maintenance fees. In some aspects, the servicer may collect a fee for maintaining the pool. The servicer's duties may be subject to a servicer agreement 253. The servicer agreement may contain provisions related to the calculation and payment of premiums, the provision of numbers to be included in a monthly report on the servicing of the insurance pool, how the policies should be tracked as they mature, how to file a claim with the carrier, and other provisions appreciated by those of skill in the art. In some aspects, the trustee may ensure that the policies in the pool stay in force until they mature, that the premiums of the policies are paid on time, that the financing product is properly drawn from to maintain the policies, that tax returns and other reporting documents are properly filed, that any taxes are paid, or any other requirements of maintaining a pool of insurance policies appreciated by those of skill in the art.

Other combinations and orderings of the segments in the system of FIG. 2 are contemplated by various aspects and embodiments of the present invention. The ordering and combination of FIG. 2 is illustrative only.

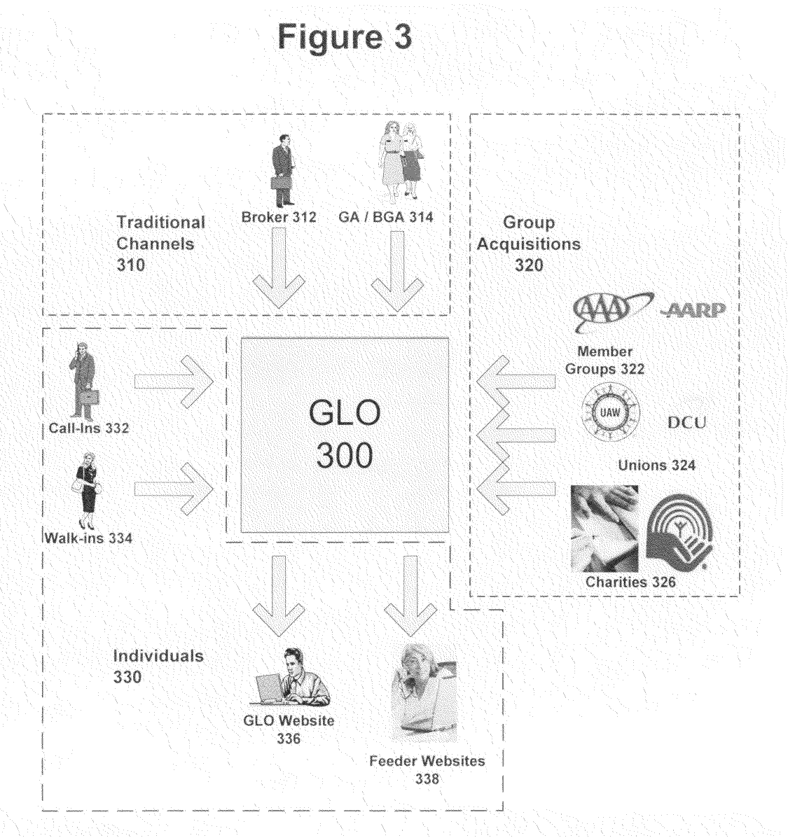

FIG. 3 illustrates the various channels for acquiring individuals interested in low-cost insurance that are contemplated by some of the various embodiments and aspects of the invention. In some aspects of the invention, traditional channels 310 for acquiring individuals seeking insurance may be utilized. In these aspects, insurance brokers 312 and Generals Agents and Broker-General Agents (GA/BGAs) 314 may find individuals seeking or in need of insurance using conventional means and forward those individuals to a service provider 300 for inclusion in an insurance pool. In some of these aspects, the insurance brokers or GA/BGAs may be paid a fee for the acquisition of individuals seeking insurance. Another channel contemplated by aspects of the invention may be groups 320. Some of these groups may be member groups 322, such as AAA™ or the AARP™, unions 324, such as the United Autoworker's Union™, or charities 326, such as the United Way™. According to some aspects of the invention, a service provider may approach such groups to offer low-cost insurance. Other aspects contemplate groups approaching a service provider. These groups may receive a commission or fee from a service provider for each individual that is acquired by the service provider. In other aspects, these groups may receive a flat fee for disseminating an offering of low-cost insurance to the group's membership on behalf of a service provider. Yet another channel contemplated by aspects of the invention may be individuals 330. Some of these individuals may come from traditional call-ins 332 or walk-ins 334 of individuals interested in a service provider. In other aspects, a service provider may have a website 336 where individuals may get information about the service provider or sign-up for services from the service provider. Still other individuals may discover a website from an affiliate or a feeder organization 338 that describes the low-cost insurance provided by a service provider. An individual may then be directed to the service provider through the affiliate or feeder website. In some aspects of the invention, these affiliate or feeder organizations may be paid a fee or commission for the acquisition of individuals seeking insurance.

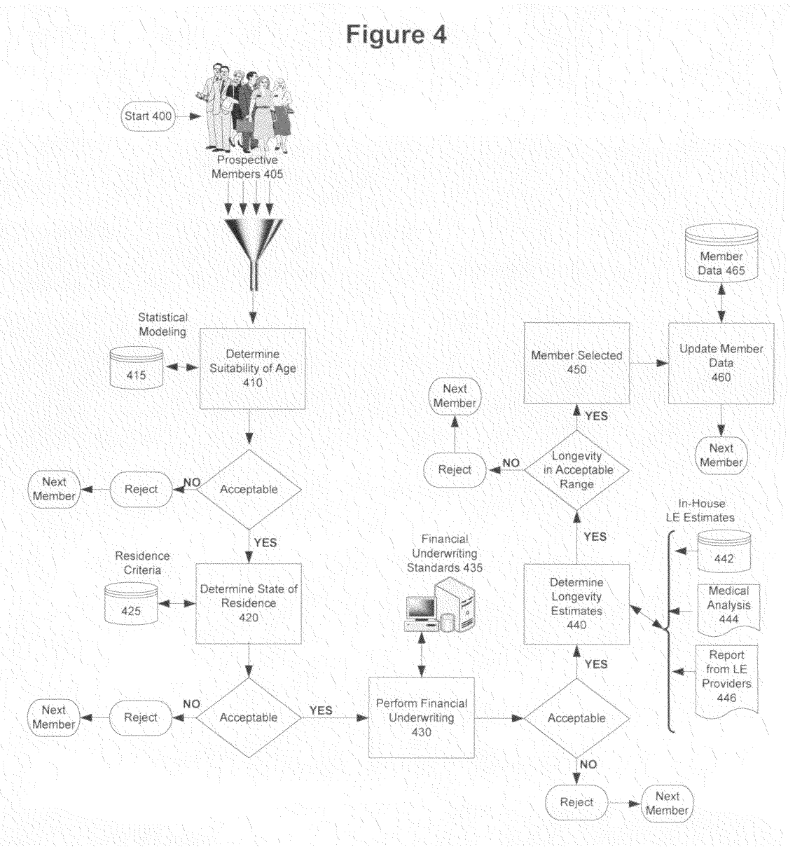

FIG. 4 illustrates a method for selecting members for inclusion in a pooled insurance entity according to one of the embodiments of the invention. In some aspects of the invention, the method begins at step 400 with a group of individuals 405 that are interested in acquiring low-cost insurance from a service provider. These individuals may provide information about themselves to the service provider in order to be considered for selection into a pooled insurance arrangement. At step 410, the age of each individual may be evaluated to determine suitability. According to some embodiments of the invention, statistical models contained in a database or server 415 may be applied to the age of the individual being evaluated, along with any other information available to the database or server. In an illustrative example, an individual may have a suitable age if they are older than fifty and younger than seventy-five. In other illustrations, an individual may be suitable if they are older than a specified age, younger than a specified age, or between two specified ages. In other aspects and examples, the ages used to determine suitability may fluctuate based upon the existing membership of insurance pools, or requirements of available lenders or carriers. If the individual has an acceptable age, they may move to step 420. If an individual has an unacceptable age, they may be rejected and analysis may begin again with another individual.

According to aspects of the invention, the residence (state, county or zip-code or other geographic or political sub-division, etc) of the individual may be evaluated for suitability at step 420. In some of these aspects, residence criteria on a database or server 425 may be used to evaluate the suitability of an individual's residence. In an illustrative example, an individual may have a suitable residence if he resides in a jurisdiction where a service provider has a legal entity allowed to hold insurance in a custodial manner. Other examples may find suitable residences if the jurisdiction of the residence allows the custodial holding of insurance regardless of whether a service provider currently has an entity in that jurisdiction. If the individual has an acceptable residence, they may move to step 430. If an individual has an unacceptable residence, they may be rejected and analysis may begin again with another individual.

According to aspects of the invention, financial underwriting may be performed for the individual at step 430. In some of these aspects, financial underwriting standards 435 may be consulted when conducting the financial underwriting. Upon underwriting, step 430 may also evaluate the individual against the financial underwriting standards to determine if the individual will be able to receive a suitable insurance policy for membership in a pool. In one illustrative example, an individual must be able to meet certain premium requirements, where an individual's insurance premium may not be larger than a certain percentage of the value upon maturity. Other examples may contemplate a maximum periodic premium payment. If the individual has acceptable underwriting, they may move to step 440. If an individual has unacceptable underwriting, they may be rejected and analysis may begin again with another individual.

According to aspects of the invention, individuals may be evaluated based on longevity estimates of that individual at step 440. In some of these aspects, longevity estimates may be based upon in-house estimations and longevity models on a database or server 442, a medical analysis or physical conducted with the individual 444, and/or a report provided by an external longevity estimating entity such as an actuarial entity 446. Using these various inputs, aspects of the invention may value the underwritten policies to determine suitability. In an illustrative example, individuals with short longevity estimates, such as sick or extremely elderly individuals, or individuals with long longevity estimates, such as young individuals, may be beyond the acceptable range of values. If the valuation of the policy with longevity estimation is within an acceptable range, they may move to step 450. If an individual is beyond the range, they may be rejected and analysis may begin again with another individual.

At step 450, the individual may have passed the selection method and is selected as a member of an insurance pool. According to some aspects of the invention, step 460 may then update a member database 465 with the individual's information. Following the update, the analysis may begin again with another individual.

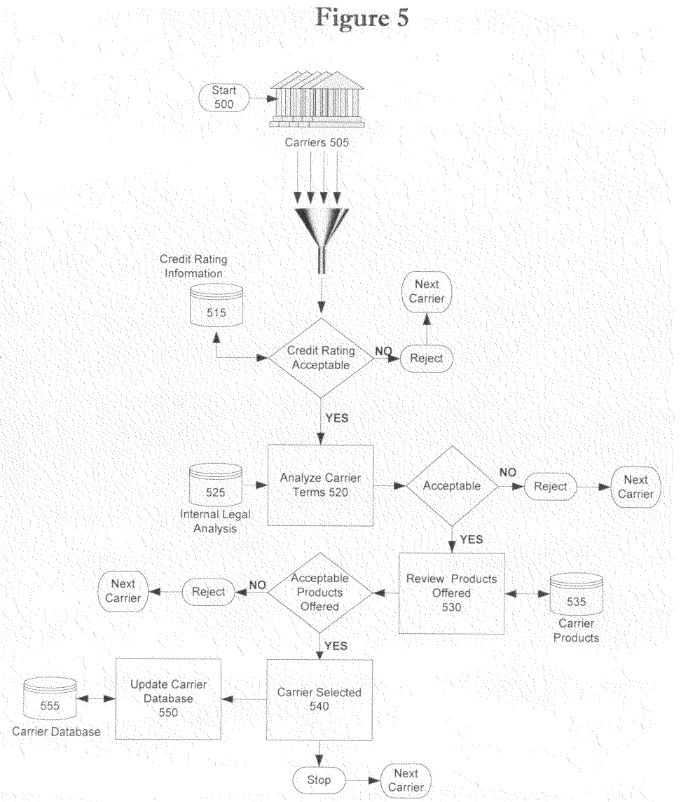

FIG. 5 illustrates a method for selecting carriers for insuring members of a pooled insurance entity according to one of the embodiments of the invention. In some aspects of the invention, the method begins at step 500 with a group of carriers 505 that are interested in providing low-cost insurance to members of a pooled insurance entity. These carriers may provide information about themselves to a service provider handling the pooled insurance entities in order to be considered for selection as a provider of insurance for the members of the pool. In some aspects, the pool may not exist at the point of selection of a carrier. In other aspects, multiple pools may exist and a carrier may be evaluated for suitability for any or all of the existing pools or any future pools. In some of the aspects of the invention, a credit rating of a carrier is evaluated at step 510. The credit rating may be evaluated using credit rating information and standards contained on a database or server 515. In some aspects, the credit rating to be evaluated may come entirely from database or server 515. This database or server may be internal to a service provider conducting the carrier selection, or may be externally provided by a third party. In some aspects of the invention, a lender to be used in financing insurance policies provided by a perspective carrier may contribute to or provide part or all of the requirements or credit ratings on database or server 515. In an illustrative example, a credit rating of A or better may be acceptable. If the carrier has an acceptable credit rating, it may move to step 520. If the carrier has an unacceptable credit rating, it may be rejected and analysis may begin again with another carrier.

According to various aspects of the invention, the terms of a carrier's insurance policies may be evaluated at step 520. Information considered in the evaluation of a carrier's offered insurance policies may include whether expedited policy issuance is available, whether guaranteed issuance is available, if the carrier allows for special pricing on policies for groups, if compensation for the provision of insurance policies is negotiable, or any other terms appreciated by those of skill in the art. A database or server 525 may evaluate and compare the terms offered by a carrier to any legal requirements imposed upon a service provider, or to internal lender or service provider requirements or standards. If the carrier has an acceptable set of terms, it may move to step 530. If the carrier has an unacceptable set of terms, it may be rejected and analysis may begin again with another carrier.

According to various aspects of the invention, the products offered by a carrier may be evaluated at step 530. A database or server 535 may evaluate and compare the products offered by the carrier against a set of preferred kinds of products. In some aspects of the invention, preferred products may be specified internally by a service provider or externally by a lender. In still other aspects, members of the insurance pools may select preferred products. If the carrier has an acceptable set of products, it may move to step 540. If the carrier has an unacceptable set of products, it may be rejected and analysis may begin again with another carrier.

At step 540, the carrier may have passed the selection method and is selected as a preferred provider of insurance policies for members of an insurance pool. According to some aspects of the invention, step 550 may then update a carrier database 555 with the carrier's information. Following the update, the analysis may begin again with another carrier.

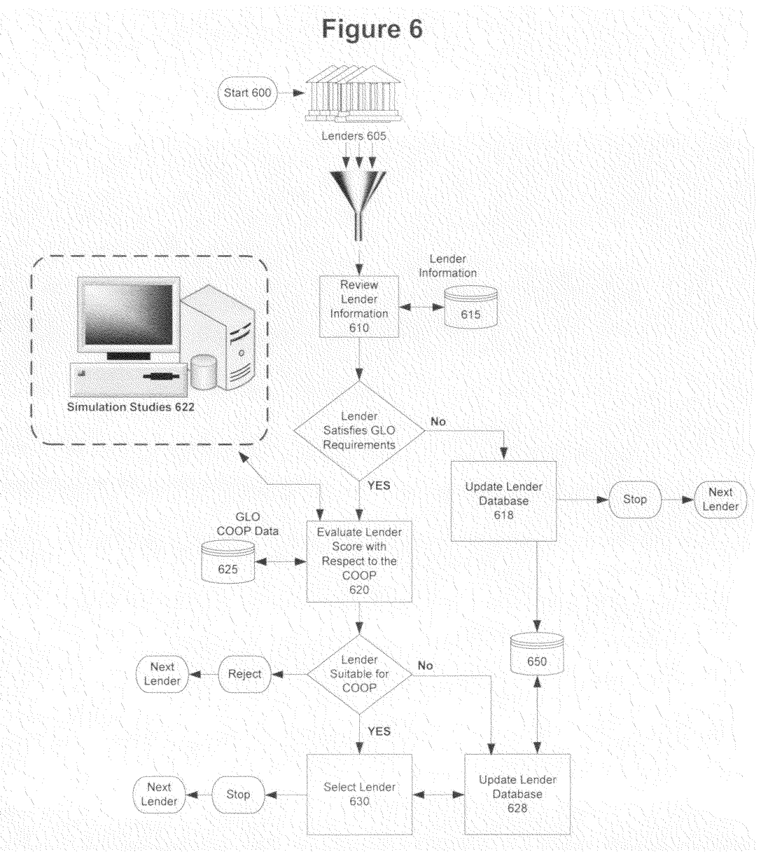

FIG. 6 illustrates a method for selecting optimal lenders for financing pooled insurance policies according to one of the embodiments of the invention. In some aspects of the invention, the method begins at step 600 with a group of lenders 605 that are interested in providing financing for low-cost insurance policies to members of a pooled insurance entity. These lenders may provide information about themselves to a service provider handling the pooled insurance entities in order to be considered for selection as a provider of financing for the members of the pool. In some aspects, the pool may not exist at the point of selection of a lender. In other aspects, multiple pools may exist and a lender may be evaluated for suitability for any or all of the existing pools or any future pools.

According to various aspects of the invention, the terms of a lender's financing offers and other information may be evaluated at step 610. Information that may be considered in the evaluation of a lender's financing offers or other information may include the size of offered loans, the asset size of the lender, the lender's credit rating, the maximum term of offered loans, the flexibility offered in loan prepayment, the interest rate offered, the prepayment penalty (if any), the maximum and minimum draw sizes, any permissible draw frequency, any commitment fee for unused loans, or any other terms appreciated by those of skill in the art. A database or server 615 may evaluate and compare the offers of a lender to any legal requirements imposed upon a service provider, or to internal service provider requirements or standards. If the lender has an acceptable set of offers, it may move to step 620. If the lender has an unacceptable set of offers, a lender database 650 may be updated with the lender's information at step 618, it may be rejected, and analysis may begin again with another lender.

According to various aspects of the invention, the lender may be evaluated with respect to an individual pool or coop of members to be insured at step 620. At this step, a set of characteristics of the pool may be used as a weight to be used in computing a lender score based on the characteristics of the lender. Information to be used in calculating the weight factor may come from a database or server 625 that holds information on existing or potential pools. In some aspects of the invention, this weighting process may include an analysis of the size of various pools, the credit rating of the lender, the interest rate offered by the lender, and the minimum term required by the lender. After weighting, a score may be calculated. In some aspects, a high score may indicate a preferred lender. In other aspects, a low score may indicate a preferred lender. In yet other aspects, a score closest to a predetermined value, such as zero or one, may indicate a preferred lender.

According to some embodiments, step 620 may also conduct simulation studies 622 on the lender in order to value policies or determine the effect a lender's offered financing product may have on the cash flow of a pool. In an illustrative example, a simulation study may randomly generate maturity dates for each policy in a pool and determine the cash flow throughout the life of the pool. This simulation may be run multiple times in order to “stress test” the financing product offered by the lender. If the lender passes this evaluation, it may move to step 630. If the lender does not pass this evaluation, a lender database 650 may be updated with the lender's information at step 628, it may be rejected, and analysis may begin again with another lender.

At step 630, the lender may have passed the selection method and is selected as a preferred provider of financing products for members of an insurance pool. According to some aspects of the invention, step 630 may then update a lender database 650 with the lender's information. Following the update, the analysis may begin again with another lender.

Maintenance

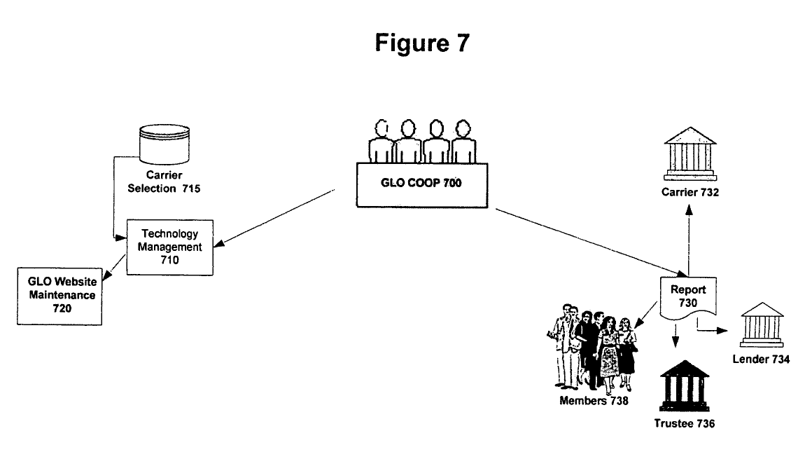

FIG. 7 illustrates methods of updating individuals and entities on the various insurance pools in operation or offered by a service provider according to various embodiments of the invention. In some embodiments of the invention, information derived from an insurance pool, such as a GLO Coop 700, may be sent to a computer or server running at a backend server, also known as a technology management server 710. In some aspects, this information may include longevity estimates of the various pools offered and in operation, current membership statistics of those pools, cash flow information, expense information, the amount of cash that has been distributed to members, the remaining balance on the financing product, or any other information collected by the service provider. The backend server may also gather information on products and other details from current preferred carriers from a carrier selection database or server 715. The backend server may then compile and forward information to the service provider's website, also known as the GLO Website 720. In some aspects of the invention, constant updates and maintenance of the website are provided by repeating the update process every time information changes regarding preferred carriers or the various insurance pools being offered or in operation. Other aspects contemplate updating the website on periodic intervals, such as once a month. Another operation of the website may be for the membership of a pool to elect or otherwise select or agree on the methods of managing the pool, such as the case of an early termination of financing, a refinancing, or a securitization of the insurance policies acting as collateral for the pool. These aspects of the invention may be conducted according to methods appreciated by those of ordinary skill in the field of electronic voting.

According to some embodiments of the invention, information derived from an insurance pool, such as a GLO Coop 700, may be compiled into a report 730. In some aspects, this information may include longevity estimates of the various pools offered and in operation, current membership statistics of those pools, cash flow information, expense information, the amount of cash that has been distributed to members, the remaining balance on the financing product, or any other information collected by the service provider. The report may be sent to any applicable carrier 732, lender 734, trustee 736, or member of the pool 738. In some aspects of the invention, the report may be customized based on the recipient of the report. As an illustrative example, a member may receive, in addition to the standard report, a personal summary of his expected payout upon maturity of his policy, his share of the pool's equity, or projections of these amounts over the course of future periods. Some aspects of the invention contemplate preparing and sending this report periodically, such as monthly. Other aspects contemplate preparing and sending the report when a change occurs in the insurance pool, such as the maturation of an individual policy in the pool. In some embodiments of the invention, this report may take the form or a letter or other publication. In still other embodiments of the invention, this report may take the form of an email or electronic newsletter. Still other embodiments of the invention contemplate other methods of transmission appreciated by those of ordinary skill in the art.

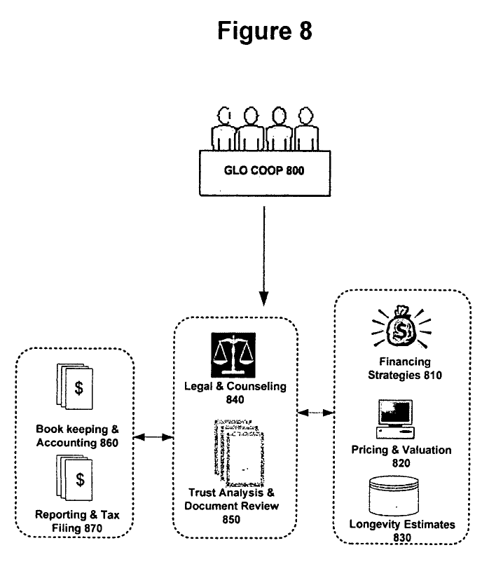

FIG. 8 illustrates methods of maintaining or improving the operation of an insurance pool according to various embodiments of the present invention. In some embodiments of the invention, an insurance pool, such as GLO Coop 800, may be maintained over the life of the pool. In some aspects of the invention, this operational maintenance may be conducted by a service provider, a trustee, a servicer, any combination of these entities, or any additional entities appreciated by those of skill in the art. Over the life of a pool, economic climates may change, the goals of the membership of the pool may change, the composition of the assets and membership of the pool may change, and other conditions effecting the operation of the pool may change. Accordingly, various embodiments of the invention contemplate the constant management and possible modification of the pool. In some of these embodiments, new financing strategies 810 may be undertaken during the life of the pool. In some aspects, financing strategies may include hedging against changing mortality risk or longevity estimates using the market, refinancing the financing product with the lender or with a new lender, hedging against interest rate risk, bifurcating risk and financing operations of the pool, securitizing the collateral of the pool using either collateralized life settlement obligations with short- and long-term tranches, or any other financing activity appreciated by those of skill in the art. In some aspects and embodiments of the invention, the financing strategy to be implemented, if warranted, may be influenced by pricing and valuation of the assets of the pool 820 and up-to-date longevity estimates on the membership of the pool 830. In aspects where refinancing, securitization, or other financing events arc considered that may cause an original financing product to be repaid, an early termination event may occur. In this instance, the pool may take control over the policies from the lender. In some embodiments of the invention, this may cause a taxable event to occur that may require reporting to regulators and members of the pool. In other aspects, a lender may require compensation in the form of an increased interest agreement, a make-whole agreement on the interest rate, a make-whole agreement on the interest rate spread, some contingent interest, a portion of the proceeds from the disposal, a prepayment penalty, a breakage fee, or reimbursement of expenses from closing out hedging and other positions and fixed payments.

According to various embodiments of the invention, the entities maintaining the insurance pool may provide legal and other counseling 840 to members of the pool. In some aspects, this counseling may take the form of assistance with the determination of beneficiaries, the increase of policy value in the pool, early exit from the insurance pool, or any other matter appreciated by those of skill in the art. In some embodiments of the invention, maintenance of the insurance pool may include the preparation and analysis of documentation and reports on the performance of the pool 850. In some aspects where the pool is a trust or other entity that must report to regulators or a governmental entity, these documents may also be provided to those entities in a reporting and tax filing 870. In some aspects, this information may include longevity estimates of the various pools offered and in operation, current membership statistics of those pools, cash flow information, expense information, the amount of cash that has been distributed to members, the remaining balance on the financing product, or any other information collected by the service provider. This information may also take the form of bookkeeping and accounting documents 860.

Maturity

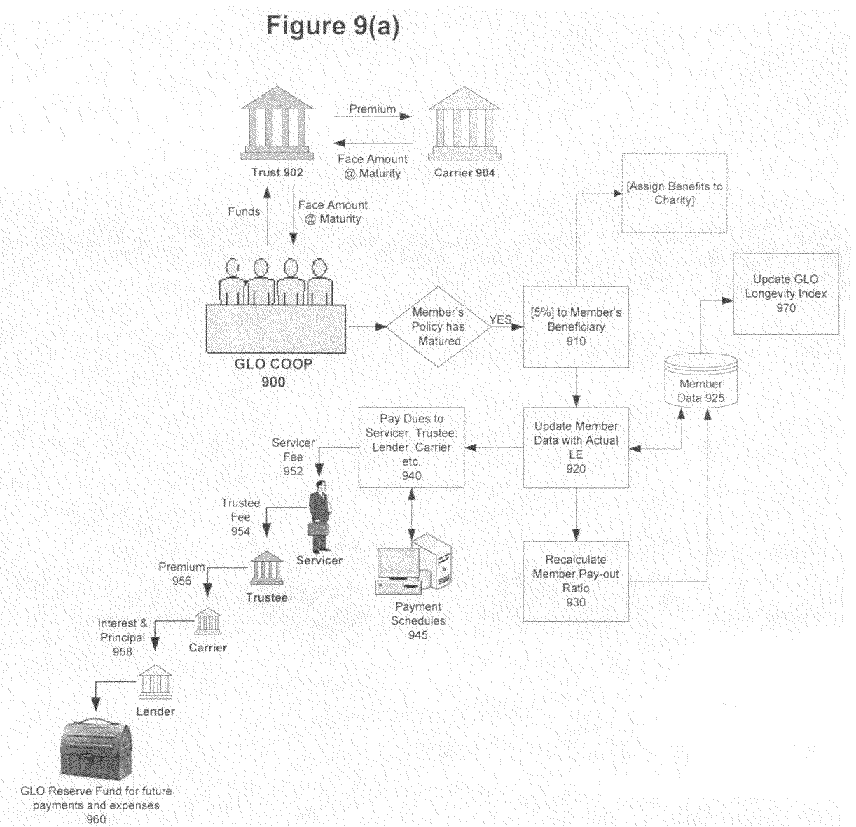

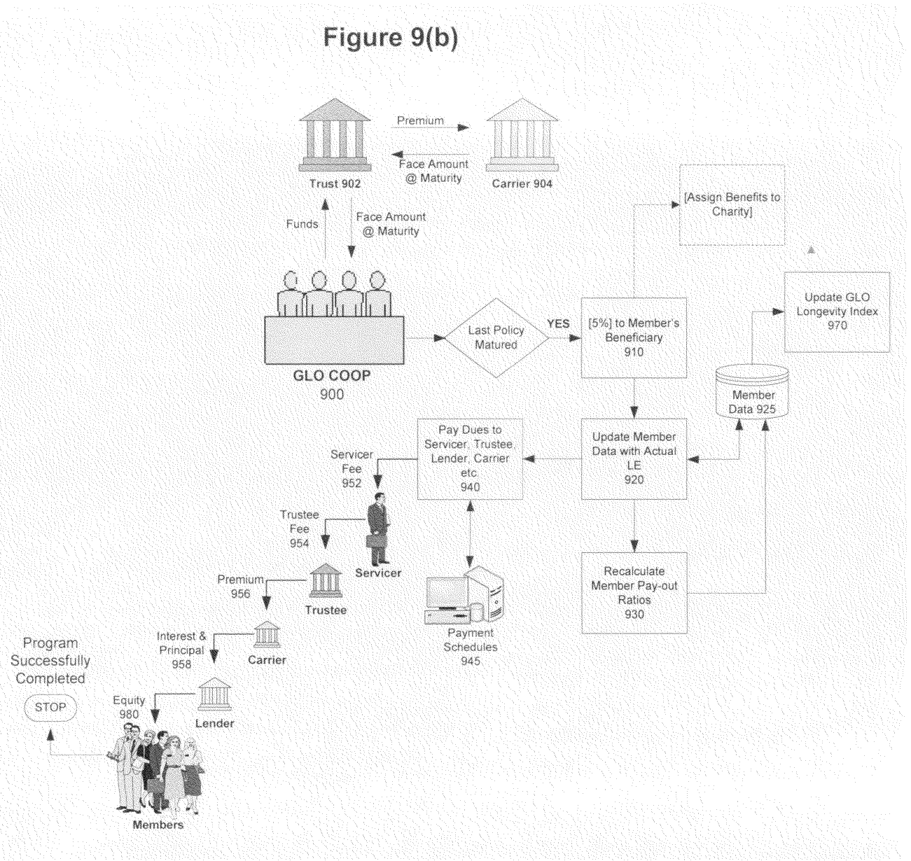

FIG. 9(a) illustrates the distribution of cash flow generated from the maturity of a policy in an insurance pool according to various embodiments of the invention. In some embodiments of the invention, an individual insurance policy may mature. Upon maturity, the carrier 904 may provide the face amount of the policy on the date of maturity to the pool 900. sometimes through a separate trust vehicle 902 that holds the policy as a custodian or as collateral for a member. In some aspects, upon receipt of the face amount, or cash flow, at the pool, the pool determines the specific member whose policy has matured. In some embodiments, the member or, in the case of life insurance, the member's beneficiary may receive a payment at step 910. The payment at step 910 may be calculated according to various methods. In one embodiment, the member or beneficiary may receive a flat payment from the cash flow, such as a predetermined dollar amount or percentage of the cash flow, so as fulfill a guarantee of payment upon maturity of the policy. This predetermined amount may be determined at the time the member enrolls in the insurance pool, or be determined by a formula that executes upon the maturity of the policy itself.

In aspects where the payment is determined by a formula that executes or that is applied upon the maturity of the policy, some aspects may base the formula upon the actual longevity of the member. In other aspects, payments may be based upon statistical modeling of the member in comparison with other members whose policies have previously matured or those members whose policies have yet to mature. Still other aspects may contemplate a combination of all of the prior-mentioned payment allocation mechanisms or others appreciated by those of skill in the art. In still other embodiments, a member or beneficiary may receive no payment upon the maturity of an individual policy, where all beneficiaries of the pool receive payments upon the maturity of the final policy in the pool. Payments may also be delivered to charities specified as beneficiaries by the member. Upon payment, or nonpayment, to a member or beneficiary, the membership database 925 is updated with data concerning the policy and member owning the policy that matured at step 920. This information may be used to update or improve the longevity estimate of the remainder of the insurance pool using actual data of the member's longevity at step 970. In some embodiments of the invention where a member pay-out or payment ratio is utilized, the remaining members' pay-out ratios may be recalculated and recorded at step 930.

According to some embodiments, upon payment, or nonpayment, to the member or beneficiary and analysis of data involving the maturity of the member's policy, the remaining cash flow may proceed to step 940. In some aspects of the invention, a waterfall of payments using the cash flow may proceed. Some embodiments may utilize payment schedules 945 in order to conduct the waterfall set of payments. Payment schedules may consist of simple periodic payments or more complex payment schemes. In various aspects of the invention, these payment schemes may be determined by the servicer, servicing agreement, trustee, lender, carrier, or any service contract entered into by the insurance pool. In accordance with various embodiments of the invention, a waterfall set of payments may include payments of any of a servicer fee 952, a trustee fee 954, a remaining premium on the policy or a premium on any of the remaining policies 956, any interest or principal due 958, or any other fees due. According to some embodiments, if any cash flow remains after the waterfall set of payments, the remainder may be deposited in a reserve fund 960 for the insurance pool. The reserve fund may be utilized by the pool if it requires additional funds for payment of periodic fees due during maintenance of the insurance pool. An illustrative example of when this might occur may be when a long period of time passes without any of the policies in the insurance pool maturing. Other embodiments of the invention contemplate any possible ordering or combination of the payments listed above in the waterfall set of payments, and the listing and ordering here is only illustrative for the purposes of describing the invention.

FIG. 9(b) illustrates the distribution of cash flow generated from the maturity of a final policy in an insurance pool according to various embodiments of the invention. In some embodiments of the invention, the final insurance policy of an insurance pool may mature. Upon maturity, the carrier 904 may provide the face amount of the policy on the date of maturity to the pool 900, sometimes through a separate trust vehicle 902 that holds the policy as a custodian or as collateral for a member. In some aspects, upon receipt of the face amount, or cash flow, at the pool, the pool determines the specific member whose policy has matured. In some embodiments, the member or, in the case of life insurance, the member's beneficiary may receive a payment at step 910. The payment at step 910 may be calculated according to various methods. In one embodiment, the member or beneficiary may receive a flat payment from the cash flow, such as a predetermined dollar amount or percentage of the cash flow, so as fulfill a guarantee of payment upon maturity of the policy. This predetermined amount may be determined at the time the member enrolls in the insurance pool, or be determined by a formula that executes upon the maturity of the policy itself. In aspects where the payment is determined by a formula that executes upon the maturity of the policy, some aspects may base the formula upon the actual longevity of the member. In other aspects, payments may be based upon statistical modeling of the member in comparison with all the other members whose policies have previously matured. Still other aspects may contemplate a combination of all of the prior-mentioned payment allocation mechanisms or others appreciated by those of skill in the art. In still other embodiments, a member or beneficiary may receive no payment upon the maturity of an individual policy, where all beneficiaries of the pool receive payments upon the maturity of the final policy in the pool and after payment of all fees and financing owed by the pool. Payments may also be delivered to charities specified as beneficiaries by the member. Upon payment, or nonpayment, to a member or beneficiary at this step, the membership database 925 is updated with data concerning the policy and member owning the policy that matured at step 920. This information may be used to update or improve the longevity estimate other or future insurance pools using actual data of the member's longevity, and the entire pool's longevity, at step 970. In some embodiments of the invention where a member pay-out or payment ratio is utilized, the final members' pay-out ratios may be recalculated and recorded at step 930.

According to some embodiments, upon payment, or nonpayment, to the member or beneficiary and analysis of data involving the maturity of the member's policy and the pool as a whole, the remaining cash flow and any other assets held by the pool, such as a reserve fund, may proceed to step 940. In some aspects of the invention, a waterfall set of payments using the cash flow may proceed. Some embodiments may utilize payment schedules 945 in order to conduct the waterfall set of payments. Payment schedules may consist of simple periodic payments or more complex payment schemes. In various aspects of the invention, these payment schemes may be determined by the servicer, servicing agreement, trustee, lender, carrier, or any service contract entered into by the insurance pool. A payment schedule may also contain a specific instruction or entry regarding the final waterfall set of payments. In accordance with various embodiments of the invention, a waterfall set of payments may include payments of any of a final servicer fee 952, a final trustee fee 954, a remaining premium on the policy or pool 956, any interest or principal remaining 958, or any other fees due. According to some embodiments, if any cash flow remains after the waterfall set of payments, the remainder may be distributed to the members or beneficiaries at step 980.

In some embodiments, distribution to members or beneficiaries may occur according to a member's overall equity stake in the insurance pool. This equity stake could be a function of the overall percentage of value of the member's policy upon maturity, the member's longevity, and any other factors appreciated by those of skill in the art. In other embodiments, a equal share distribution may take place. In still other embodiments, the pay-out ratios computed in the member database may be used to distribute remaining equity. Other embodiments of the invention contemplate any possible ordering or combination of the payments listed above in the waterfall set of payments, and the listing and ordering here is only illustrative for the purposes of the invention. Charities may be especially well-suited to receive equity as elected beneficiaries at in this step as, in some embodiments of the invention, a long time may have passed between the maturity of an individual member's policy and the maturity of the final policy in the insurance pool.

Extended Applications

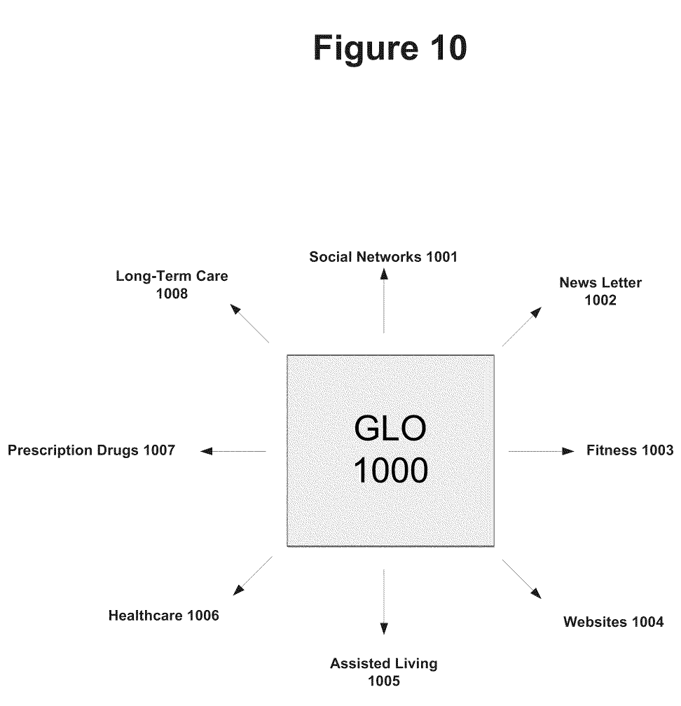

FIG. 10 illustrates various social networking-related applications available to members of an insurance pool according to various embodiments and aspects of the invention. In various aspects and embodiments of the invention, the information gathered by a service provider 1000 operating an insurance pool may be used for many different purposes. A social network 1001 may be created where members can congregate and discuss issues important to their peer group. In some embodiments, the social network may be implemented through a website 1004. The members may be of the same or of multiple insurance pools. In embodiments where anonymity is important, members may not be able to determine which members of the social network belong to their own insurance pools. The social network 1001 may also provide for the implementation of the following extended applications.

According to various embodiments, a newsletter 1002 may be provided to members of various insurance pools or to members enrolled in the social network. The newsletter may include longevity estimates of the various pools offered and in operation, current membership statistics of those pools, cash flow information, expense information, the amount of cash that has been distributed to members, the remaining balance on the financing product, or any other information collected by the service provider. In some aspects of the invention, the newsletter may be customized based on the recipient of the newsletter. As an illustrative example, a member may receive, in addition to the standard information listed above, a personal summary of his expected payout upon maturation of his policy, his share of the pool's equity, or projections of these amounts over the course of future periods. Some aspects of the invention contemplate preparing and sending this newsletter periodically, such as monthly. Other aspects contemplate preparing and sending the newsletter when a change occurs in the insurance pool, such as the maturation of an individual policy in the pool. In some embodiments of the invention, this newsletter may take the form of a paper newsletter or other publication. In still other embodiments of the invention, this newsletter may take the form of an email or electronic newsletter.

According to various embodiments of the invention, fitness 1003, assisted living 1005, heath care 1006, prescription drugs 1007, or long-term care 1008 information and services may be marketed to members enrolled in an insurance pool or the social network. Some embodiments contemplate conducting data mining operations on information held by the service provider about the members in order to offer advertising services to the providers of products and services, as well as membership organizations such as the AARP™, that specialize in individuals with similar demographics as the members of a pool. In this manner, aspects of the invention may provide for targeted marketing of various members of the social network and insurance pools to advertisers. In some embodiments of the invention, the service provider may realize advertising revenue for this service. In some aspects, members may be allowed to either “opt-in” or “opt-out” of these advertising services.

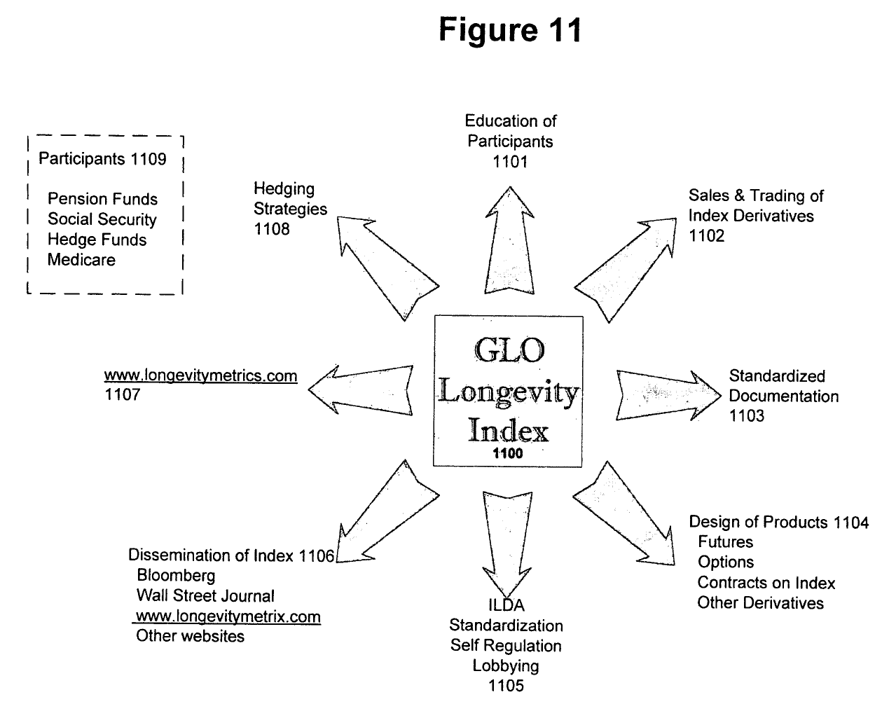

FIG. 11 illustrates various applications of a longevity index created by the operation of an insurance pool according to various embodiments and aspects of the invention. According to various embodiments of the invention, an internal longevity index 1100 may be calculated by a service provider offering and operating insurance pools. In some aspects and embodiments, this longevity index may be an index based on the aggregation of longevity estimates for all members of insurance pools managed by the service provider, as well as actual longevity data gathered in the course of administering maturing insurance policies. As more members join insurance pools operated by the service provider, and as more of the operated pools reach maturity, a thorough longevity index may be created. In some aspects, the longevity index may be segmented according to demographics such as age ranges, race, gender, occupation, income, lifestyle, overall health, geographical location, urban/rural residence, or any other demographic information appreciated by those of skill in the art. In some aspects and embodiments, the longevity index created by the service provider may be of value to third party entities 1109. According to some aspects, some of these entities may be pension funds, the social security system, hedge funds, the Medicare system, or any other program that relies upon actuarial analysis involving lifespan. In some of these aspects, the service provider may sell the dissemination of the longevity index 1106, in whole or part, to these entities, such as Bloomberg™, the Wall Street Journal™, and Longevitymetrix.com™. Access may be provided through a longevity index website such as longevitymetrics.com 1107. In some other aspects, the service provider may provide access to the longevity index, in whole or part, in exchange for a discount on services, such as from a lender or carrier involved in insurance pools.

Various aspects of the invention contemplate multiple applications for the longevity index. One such application may be the education of existing or future participants in an insurance pool 1101. In this instance, a longevity index may better inform a prospective member on the realistic outcomes of becoming involved in an insurance pool. In the case of an existing member, he may receive more accurate assessments of his future payouts upon maturity of his and the overall pool policies. In another application, an index derivative 1102 may be created based upon the longevity index itself. This derivative could trade over-the-counter to parties that would like to either hedge or bet on longevity changes in the population. In another application, the longevity index could be used to create a standard for longevity estimations to be used in documentation 1103 that would ordinarily reference conventional actuarial analysis. In this instance, all documentation relating to longevity could have a standardized metric to adhere to. Other organizations such as lobbying or sell-regulating entities 1105 may also use the index as a standard measure in their course of business. In another application, service provider or third-party designed financial products could be based, in part, on the longevity index. Some of the contemplated financial products may include futures, options, contracts based on an index derivative, or other exotic derivatives appreciated by those of skill in the art. Yet another application may be the inclusion of the longevity index as a component or variable in the formulation of hedging strategies 1108. These hedging strategies may be used by either the service provider in realizing a greater return on assets from the policies maintained by the insurance pools, or by third-party entities that conventionally have used actuarial analysis in their hedging strategies.

Having described a number of different embodiments of the invention, it should be apparent to the person of ordinary skill that the invention has numerous benefits and advantages. For example, the pooling of various individuals into a collective borrowing entity allows for a lender to dramatically mitigate the mortality risk normally present in the financing of insurance policies.

The ability for an insurance carrier to spread the risk of early maturity of policies over a large pool of individuals greatly reduces the risk normally present when providing insurance to elderly and other at-risk individuals.

Further, the ability to mitigate the risks of both lenders and carriers allows individuals seeking insurance to receive insurance at lower interest rates and with lower premiums. Some individuals will even be able to receive insurance through an insurance pool where they would not be able to do so individually.

Because the invention allows all parties to a financed insurance arrangement to benefit from the provision, maintenance, and maturity of insurance policies, all parties will be enriched in the form of greater cash flow, easier maintenance of the insurance arrangement, and reduced stress from the start to finish of the life of the policies involved.

Other benefits and advantages of the invention will be apparent to the person of ordinary skill in the art.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention. For example, the description of the various embodiments of the invention given above may also include the use of all mortality based products, such as annuities, in place of or in addition to the use of life insurance policies.

What is claimed is:

1. A computer-implemented method of providing insurance, comprising:
determining a plurality of individuals to be insured based on financing provided by a financial instrument,
pooling the individuals into an entity;
receiving the financing instrument issued by a lender and for the benefit of the entity;
providing insurance policies for the individuals based on the financing instrument;
the pooled entity making payments to service the financial instrument, and
wherein the individuals do not make premium payments for the insurance policies.

2. The method of claim 1, further comprising:
realizing a cash inflow from at least one of the insurance policies reaching maturity; and
paying down at least a portion of the financing instrument with the cash inflow.

3. The method of claim 2, wherein the realizing a cash inflow and paying down steps are repeated for all of the individuals in the entity.

4. The method of claim 2, wherein the realizing a cash inflow and paying down steps are repeated for all of the insurance policies except for a last surviving policy in the entity.

5. The method of claim 4, further comprising:
realizing a terminal cash inflow from the last surviving policy in the entity reaching maturity;
if the financing instrument is not paid-off, paying down the remainder of the financing instrument; and
distributing the remainder of the terminal cash flow to the individuals or the estates of the individuals.

6. The method of claim 4, further comprising:
paying a fee for the maintenance of the policies from the terminal cash flow.

7. The method of claim 2, wherein, after the financial instrument is paid-off, the remainder of the cash inflow is held by the entity as equity.

8. The method of claim 7, further comprising:
distributing the equity of the entity to the individuals or to the estates of the individuals.

9. The method of claim 2, wherein, after the financial instrument is paid-off, the remainder of the cash inflow is distributed to the individuals of the entity.

10. The method of claim 2, further comprising:
paying a fee for maintenance of the policies from the cash flow.

11. The method of claim 1, wherein the entity is a holder of the insurance policies.

12. The method of claim 1, wherein the plurality of individuals to be insured are senior citizens.

13. The method of claim 1 wherein the entity is selected from a group consisting of a trust, a statutory trust, a common law trust, a charitable trust, a cooperative, a limited liability company, an S-corporation, a corporation, and an association.

14. The method of claim 1, wherein the entity is one of a plurality of parent-subsidiary entities.

15. The method of claim 1, wherein the financing instrument is selected from a group consisting of a secured loan, an unsecured loan, a line of credit, and a factoring agreement.

16. A computer-implemented method of providing insurance, comprising:
determining an individual to be insured based on financing provided by a financial instrument;
determining an entity;
pooling the individual into the entity;
receiving the financing instrument issued by a lender and for the benefit of the entity;
providing an insurance policy for the individual based on at least a portion of the financing instrument;
the pooled entity making payments to service the financial instrument; and
wherein the individual does not make premium payments for the insurance policy.

17. The method of claim 16, wherein the entity is a pool of individuals seeking insurance.

18. The method of claim 16, further comprising:
realizing a cash inflow from the insurance policy reaching maturity; and
paying down at least a portion of the financing instrument with the cash inflow.

19. The method of claim 18, further comprising:
paying a fee for maintenance of the policy from the cash flow.

20. The method of claim 16, further comprises, if the insurance policy is the last surviving policy in the entity:
realizing a terminal cash inflow from the insurance policy reaching maturity;
if the financing instrument is not paid-off paying down the remainder of the financing instrument; and
distributing the remainder of the terminal cash flow.

21. The method of claim 20, further comprising:
paying a fee for maintenance of the policy from the terminal cash flow.

22. The method of claim 20, wherein the remainder of the terminal cash flow is distributed to the individual or the estate of the individual.

23. The method of claim 20, wherein the remainder of the terminal cash flow is distributed to beneficiaries of the entity.

24. The method of claim 16, wherein, after the financial instrument is paid-off, the remainder of the cash inflow is distributed to the individual.

25. The method of claim 16, wherein, after the financial instrument is paid-off, the remainder of the cash inflow is held by the entity as equity.

26. The method of claim 25, further comprising:
distributing the equity of the entity to the beneficiaries of the entity.

27. The method of claim 16, wherein the entity is a holder of the insurance policy.

28. The method of claim 16, wherein the individual to be insured is elderly.

29. The method of claim 16, wherein the entity is selected from a group consisting of a trust, a statutory trust, a common law trust, a charitable trust, a cooperative, a limited liability company, an S-corporation, a corporation, and an association.

30. The method of claim 16, wherein the entity is a plurality of parent-subsidiary entities.

31. The method of claim 16, wherein the financing instrument is selected from a group consisting of a secured loan, an unsecured loan, a line of credit, and a factoring agreement.

32. A computer-implemented system for providing insurance, comprising:
a processor that:
determines a plurality of individuals to be insured based on financing provided by a financial instrument;
pools the individuals into an entity;
receives the financing instrument issued by a lender and for the benefit of the entity; and
provides insurance policies for the individuals using the financing instrument;
wherein the pooled entity makes payments to service the financial instruments; and
wherein the individuals do not make premium payments for the insurance policies.

33. A computer-readable medium with instructions thereon that when read by a processor cause the processor to:
determine a plurality of individuals to be insured based on financing provided by a financial instrument;
pool the individuals into an entity;
receive the financing instrument issued by a lender and for the benefit of the entity;
provide insurance policies for the individuals based on the financing instrument;
wherein the pooled entity makes payments to service the financial instrument, and
wherein the individuals do not make premium payments for the insurance policies

34. A computer-implemented method of pooling an individual to be insured, comprising:
determining the age of an individual;
determining the residence of the individual
determining a longevity estimate of the individual; and
pooling the individual into an insurance purchasing entity based, at least in part, on the age, the residence, and the longevity estimate of the individual.

35. A computer-implemented method of distributing a cash flow from a matured insurance policy in an insurance pool, wherein the policy is directed towards an individual and financed by the insurance pool via a lender, comprising:
distributing a first amount of the cash flow to a beneficiary of the individual;
distributing a second amount to pay fees for maintenance of the policy;
distributing a third amount to pay for interest and principle to the lender; and
distributing a fourth amount to the insurance pool.

36. The method of claim 35, wherein the insurance pool holds the fourth amount as at least part of an equity and wherein all policies in the insurance pool have matured, further comprising:
distributing at least part of the equity of the insurance pool to the beneficiary of the individual.
